(19) United States
(12) Patent Application Publication
(10) Pub. No.: US 2018/0339746 A1
(43) Pub. Date: Nov. 29, 2018

(54) RIM BRAKE SYSTEM AND A TIRE

(71) Applicant: I.G. CARDBOARD TECHNOLOGIES LTD., Tel Aviv (IL)

(72) Inventor: Izhar GAFNI, Ahituv (IL)

(73) Assignee: I.G. CARDBOARD TECHNOLOGIES LTD., Tel Aviv (IL)

(21) Appl. No.: 15/776,659

(22) PCT Filed: Oct. 20, 2016
(86) PCT No.: PCT/IL2016/051143

§ 371 Date: May 16, 2018

(30) Foreign Application Priority Data
Nov. 16, 2015 (IL) 242631
Nov. 16, 2015 (IL) 242632
Apr. 4, 2016 (GB) 1605731.7

(51) Int. Cl. B62L 1/14; B60B 21/08; B60C 15/02; B62L 1/00

(52) U.S. Cl. CPC B62L 1/14; B60B 21/08; B60B 2900/325; B62L 1/005; B60C 2200/12; B60C 15/023

(57) ABSTRACT

The present disclosure concerns tires and a rim brake system for a wheel fitted with such tires..

### TECHNOLOGICAL FIELD

The present disclosure concerns tires and a rim brake system for a wheel fitted with such tires.

### BACKGROUND ART

References considered to be relevant as background to the presently disclosed subject matter are listed below:

WO 2011/067742

U.S. Pat. No. 3,921,764

U.S. Pat. No. 3,114,434

FR 1141172

EP 2743095

US 2014/015307

GB 191009830

GB 191107930

DE 2157076

GB 940062

Acknowledgement of the above references herein is not to be inferred as meaning that these are in any way relevant to the patentability of the presently disclosed subject matter.

### BACKGROUND

Rim brakes are inexpensive, light, mechanically simple, easy to maintain, and generally powerful. However, they suffer from some drawbacks. For one, the braking power directly correlates to the force the rider applies to the braking lever. In addition, brake pads wear down and have to be replaced regularly. Some types of rim brakes, e.g. dual pivot, require that the rim be relatively straight; if the rim has a pronounced wobble, then either the brake pads rub against it when the brakes are released, or apply insufficient or uneven pressure to the rim.

In use, the brake pads also heat because the brake functions by friction, which results in converting kinetic energy into thermal energy. In normal use this is not a problem, as the brakes are applied with limited force and for a short time, so the heat quickly dissipates into the surrounding air. However, on a heavily-laden bike on a long descent, heat energy is added more quickly than it can dissipate and temperature of the pad may increase to cause accelerated wear; and in the event of excessive heat the pads may fail to brake which may be a cause of accidents.

### GENERAL DESCRIPTION

The present disclosure provides, by a first of its aspects, a rim brake system for a wheel. The system comprises a frame, positioned adjacent an upper portion of the wheel (namely a portion that is upward the wheel's axle) and holding at least one brake element, preferably at least one pair of brake elements. Each of the elements has a rim-bearing face that faces the wheel's rim. Where the rim brake system comprises a pair of elements, each member of the pair is opposite one another and faces an opposite rim of the wheel than that of the other element of the pair. Each of the elements can move in opposite forward and rearward directions and hence reciprocate between a front position and a rear position. Each of the elements is biased by at least one urging element to move in the forward direction into its front position. Each of the elements is configured such that, in its rear position, the rim-bearing face is distanced from the rim, while this distance is gradually diminished with the forward movement of the brake element, said face comes to bear onto the rim in said element's front position. The rim brake system also comprises an actuation element associated with a second urging element, the actuation element can be displaced between first and second states and is biased into its first state in which it forces the braking elements to be in their rear position against the bias of the first urging element. The actuation element is coupled to a user-operable actuation mechanism, for example one comprising a brake lever, and through user actuation thereby switches the actuation element into its second state; whereby the brake element is free to move into its front position.

The configuration of the rim brake system of this first aspect permits the build-up of a braking force in a manner independent of the force applied by a user. In the system of this disclosure, the main effect of user actuation is to release the brake element and permit it to move forward by the biasing force of the first urging member (or members). This forward movement is accompanied by a gradual diminishing of the lateral distance between the rim-bearing face and the wheel's rim until said face bears onto said rim. This bearing induces a braking force, while the on-going forward rotation of the wheel drags the brake element a further distance forward, causing it to bear stronger onto the rim. Thus, the braking force is amplified by the forward movement of the wheel.

In some embodiments, the system may be configured to function in an “all or none” manner, namely, that upon user actuation and consequent release of the arresting force of the braking element, a braking force is exerted which is completely user-independent. This may be useful, for example, in slow moving vehicles, such as a wheelchair. In other embodiments, the system may be configured to permit gradual actuation, namely, such that partial actuation may permit forward displacement of the brake element up to a certain point and further actuation may permit it to advance a little further, etc.; and thereby gradual or stepwise user-controlled braking force may be exerted. However, as distinct from existing rim brake systems, even in such a case the braking force is not dependent on the force applied by the user.

The frame of a system of said first aspect is typically fitted on or attached to an upper end of the wheels' fork.

The brake element in said first aspect, according to some embodiments, comprises a brake pad with the rim-bearing face defined by it. The rim-bearing face is generally parallel to the rim's side face. The brake pad may be hinged to a pivot arrangement configured to permit the forward-rearward reciprocation, while maintaining the general parallel orientation of the rim-bearing face. By one embodiment, the brake pad is a generally planar element.

The pivot arrangement may comprise a front pivot unit that is hinged to a front portion of a brake pad and a rear pivot unit hinged to a rear position of said brake pad. The two pivot units have a generally parallel orientation to one another. This arrangement provides for a fixed spatial orientation of the brake pad during its forward-rearward reciprocation. By an embodiment, each of the two pivot units is associated with a respective first urging member.

By an embodiment of the first aspect of this disclosure, each of the brake elements has an arm member connected to or integral with the brake pad which is configured to engage said actuation element. The actuation element may be hinged to the frame and is displaceable between its first and second states in a hinged manner

By a second aspect, this disclosure provides a rim brake system that comprises a frame holding at least one brake element with a rim-bearing face that faces the wheel's rim. Each of the elements is capable of displacement between a rim engaging state in which its rim-bearing face bears against the rim, and a rim disengaging state in which its rim-bearing face is distanced from the rim. The system is characterized in that (i) the rim-bearing face is devoid of an elastomeric material; and in that (ii) the brake element is configured so as to cause the rim-bearing face to bear against a portion of the rim that comprises or is fitted with an elastomeric material. In this manner, rather than generating brake-causing friction between the elastomeric surface of a brake pad and a non-elastomeric rim portion, as in known rim brake systems, the rim-bearing face (being typically part of a brake pad) generates brake-causing friction with an elastomeric surface of the wheel's rim. Thus, for example, the heat that may be generated owing to such friction is distributed over a large surface of elastomeric material and is quicker to dissipate. Hence, the risk of excessive heating that induces wear, and in extreme cases loss of braking efficiency, is considerably reduced.

By an embodiment of this second aspect, the brake element is configured to cause the rim-bearing face to bear against the rim of a ground-bearing elastomeric element of the wheel, for example, against the rim of the wheel's tire. By another embodiment, the wheel's rim is fitted with a dedicated elastomeric sheet serving as a brake-forming surface, and the brake element is configured to cause the rim-bearing face to bear against said sheet.

As can be appreciated, the rim brake system of the first aspect and that of the second aspect are independent aspects one from the other. However, the rim brake system of this disclosure may also be configured to embody features of both of these aspects. This means, that (i) the rim-bearing face of the system of the first aspect may be fitted with an elastomeric material and hence the brake element may be configured to cause it to bear against the non-elastomeric portion of a wheel's rim, or alternatively, (ii) the rim-bearing face is not fitted with an elastomeric material and hence the brake element is configured to bring it to bear against an elastomeric portion of the rim.

Provided by a third aspect of this disclosure is a tire and a wheel that is fitted with such a tire. The tire comprises a circumferential tire body with a circumferential sealed compartment that is defined between a tire base and a circumferential ground-bearing portion, and two flanking portions integral with tire body generally parallel one to the other. The tire of this aspect may be employed in a rim brake system of this disclosure.

The tire is, typically, made of an elastomeric material; for example vulcanized rubber. The circumferential compartment may be filled with a gas (e.g. air), optionally pressurized, or a shock-absorbing material or an elastomeric material softer than the tire material.

As the compartment is of deforming (due to its filling with gas or a softer material), the circumferential sealed compartment may function as a shock absorber when a rider rides a vehicle (such as a bicycle) over a bumpy surface. When filled with non-compressed air or another elastomeric material, the tire functions as a non-pneumatic, tubeless (and/or airless) tire, thereby circumventing the need to maintain a suitable air-pressure in the tire and/or risking a flat-tire.

A wheel that is fitted with such a tire comprises a wheel body, a rim portion and a circumferential surface, and a tire of the kind specified above. In the wheel the tire base is associated with the circumferential surface and the two flanking portions are fitted over the wheel's rim portion. The association between the tire base and the circumferential surface or between the flanking portions and the rim portions may be by adhering (e.g. by gluing) or by pressure fitting.

When utilizing the tire and/or wheel of this disclosure, the rim brake system comprises a frame holding at least one brake element with a rim-bearing face that faces the wheel's rim, each of the elements being capable of displacement between a rim engaging state in which its rim-bearing face bears against the rim and a rim disengaging state in which its rim-bearing face is distanced from the rim; and being characterized in that the rim-bearing face being devoid of an elastomeric material, and in that the brake element is configured so as cause the rim-bearing face to bear against the flanking portions of the tire fitted over the wheel's rim.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a schematic illustration of an exemplary bicycle with its front wheel fitted with a brake system according to an embodiment of this disclosure.

FIG. 2 is a schematic close-up, isometric rear view illustration of the brake system.

FIG. 3 is a schematic isometric front view illustration of the brake system of FIG. 2 in isolation.

FIG. 4 is an enlarged isometric rear view, showing a large view of the frame with its associated elements.

FIGS. 5A and 5B are respective rear view and schematic upper view of a portion of the brake system with the brake element being in the rear position in which the rim-bearing face is distanced from the wheel's rim.

FIGS. 6A and 6B are the same views as in FIGS. 5A and 5B, respectively, with the brake elements in its front position in which the rim-bearing face bears against the wheel's rim.

FIGS. 7A, 7B and 7C show a side view of a tire according to an embodiment of this disclosure, a cross-sectional view of the tire and a cross-section of a wheel fitted with such a tire, respectively.

### DETAILED DESCRIPTION OF EMBODIMENTS

In the following description, the rim break system of this disclosure will be described with reference to an exemplary implementation, according to an embodiment of this disclosure, in which it is fitted onto a fork of a bicycle. The illustrated bicycle which comprises cardboard as its main building block is disclosed in WO 2011/067742. As can be appreciated, the rim brake system of this disclosure may be implemented in a variety of different embodiments that may implemented in bicycles of different kinds, on wheelchairs, on a variety of other wheeled devices.

In addition, as will also be clarified from the description below, the disclosed embodiments combine features of the first and second aspects of this disclosure, as described above. In other words, the rim-bearing face of the brake element is devoid of elastomeric material and bears against an elastomeric layered surface of the rim. However, as can be appreciated, the general configuration of the brake system of this embodiment is applicable also in the case of a braking surface fitted with an elastomeric material. Furthermore, as can also be appreciated, the illustrated rim brake system is but an exemplary embodiment of a rim brake system with a rim-bearing face which is devoid of elastomeric material that bears against an elastomeric surface on the wheel's rim so as to yield a braking force and there may be different configurations of different embodiments of a rim brake system with such a characteristic. For example, rim brake system of a general conventional design in which the brake power is proportional to the braking force applied by the user on the brake lever, but with a rim-bearing face of a brake element that is devoid of an elastomeric material and that bears against an elastomer-covered surface of the rim.

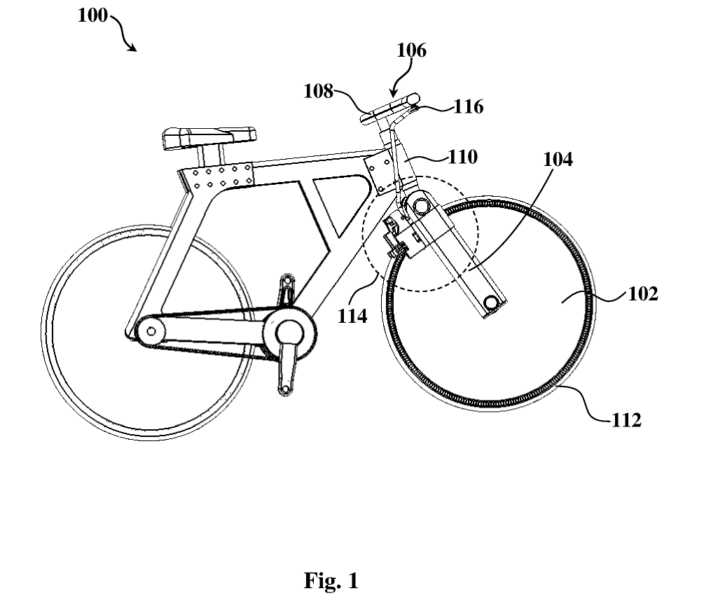

With all this in mind, reference is now being made to FIG. 1 showing the bicycle 100 with a front wheel 102, coupled to the bicycle's frame via fork 104, which is part of a steering assembly 106 including handlebar 108 and a stem held within a head tube 110. The wheel is fitted with a tire and the wheel's rim is layered with an elastomeric material 112. As can be appreciated, in some embodiments, the elastomeric material 112 may be independent of the tire; in other embodiments it may be integrally formed with the tire and a lateral extension thereof.

Also seen in FIG. 1 is a general view of the rim brake system designated 114 that includes a brake lever 116 and frame 118 holding system's elements to be described below, coupled to one another by a coupling link 120. The frame is fixed at an upper end of the fork and is, hence, positioned adjacent an upper portion of the wheel. This portion of the wheel rotates in a general forward direction during forward movement of the bicycle.

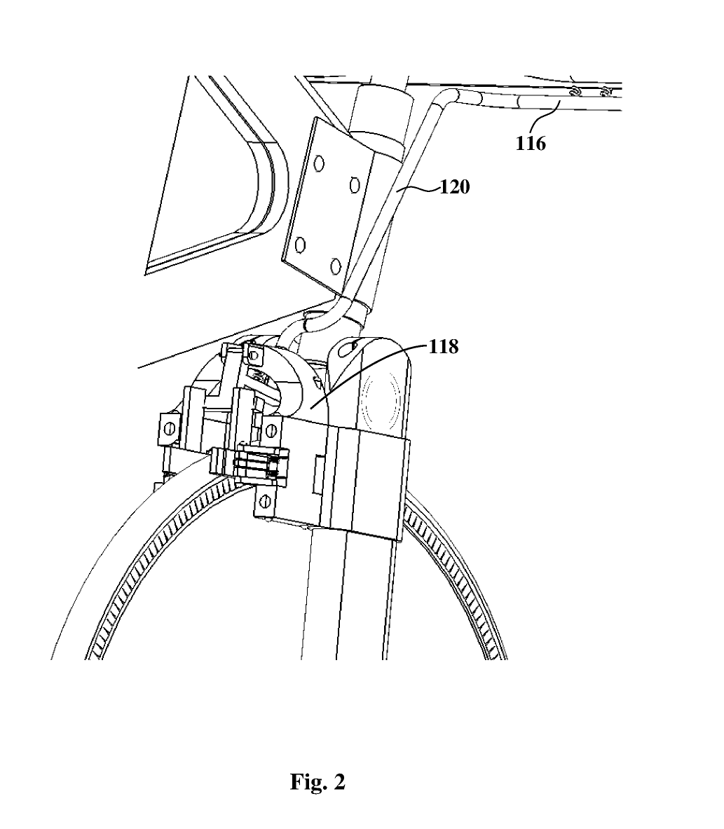

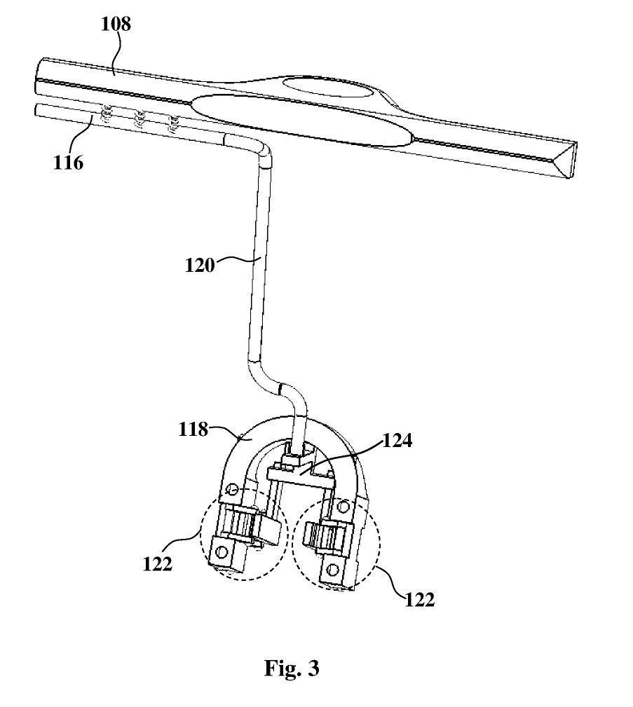

Frame 118 and its elements may be better seen in FIGS. 2-4. The frame 118 has a generally horseshoe shape and holds the main functional elements of the brake system, which includes a pair of brake elements 122 opposite one another and facing each an opposite rim of the wheel than that of the other. The frame also holds an actuation element 124 which is coupled through coupling link 120 to the user actuation mechanism, being, in the exemplary embodiment, in the form of a brake lever 116. It should be noted that a user operable actuation mechanism in the form of a brake lever is but one example of many different embodiments of user actuation mechanisms, which may be configured in a manner different than a hand-operated brake lever, such that actuation by a pedal, may be electrically, mechanically, pneumatically, hydraulically actuated, etc. Thus, for example, where the user actuated mechanism is electrically, hydraulically or pneumatically operable, coupling link 120 may be configured accordingly. By way of example, where the actuation is electrical, the frame may also hold a solenoid coupled to a user actuated button configured to actuate the actuation element.

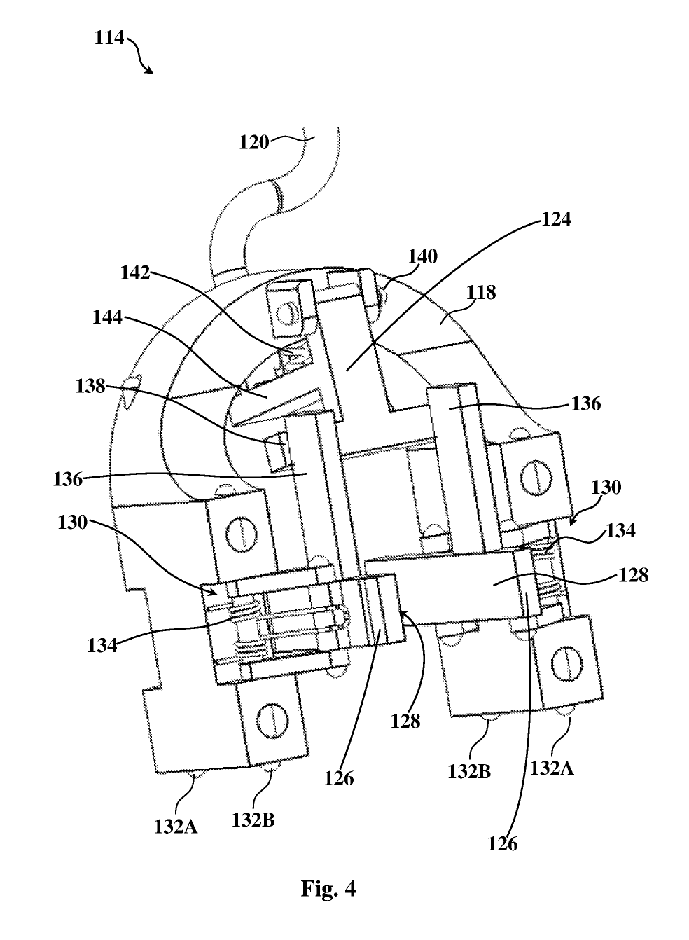

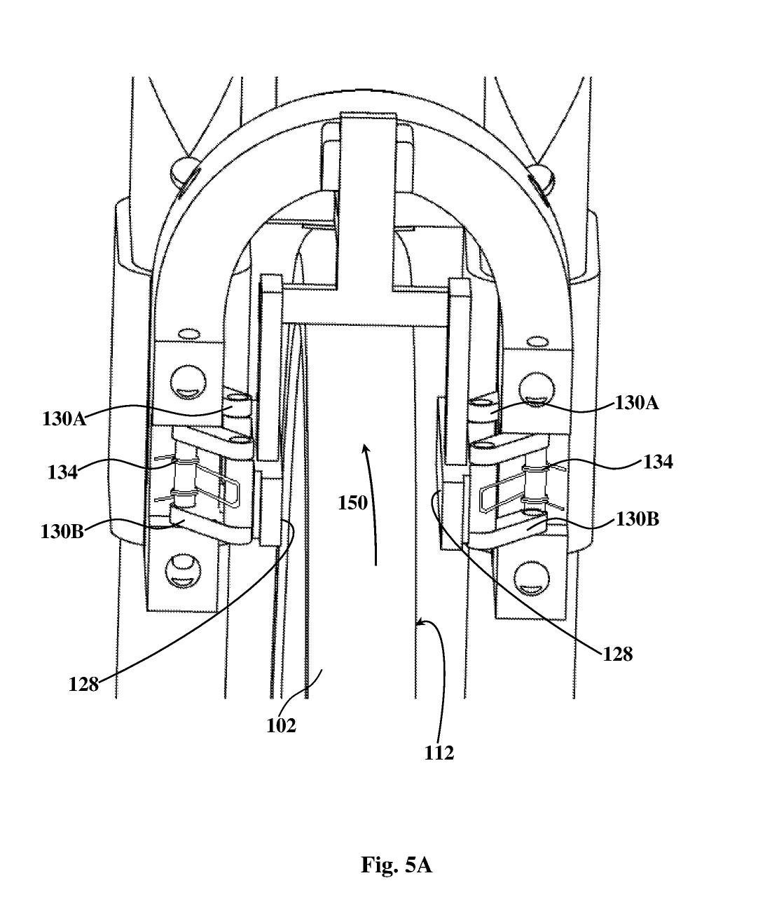

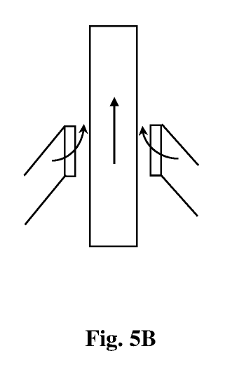

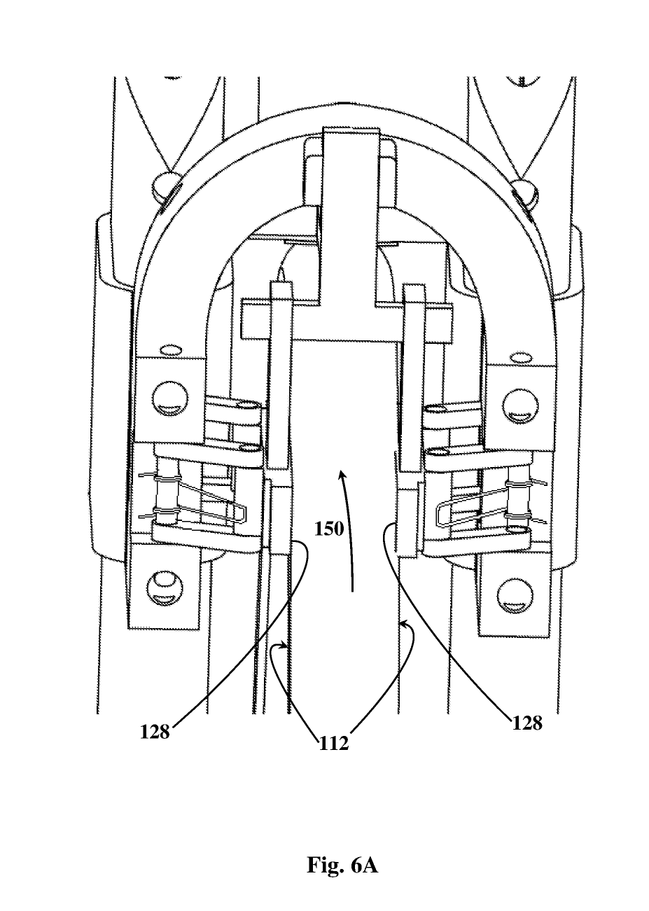

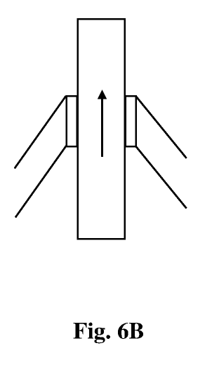

As can best be seen in FIG. 4, each of the brake elements 122 includes a brake pad 126 that defines a rim-bearing face 128. Each brake pad 126 is connected to the frame via two pivot units 130A and 130B which are essentially parallel to one another. Of these, one pivot unit 130A is hinged to a front portion of the brake pad and the other pivot unit 130B is hinged to a rear portion of the brake pad. The pivot units 130A and 130B are in turn pivoted to the frame about respective axles 132A and 132B. Each of the pivot units is associated with a first urging element in the form of a spring 134 which exerts a biasing force on the brake element to urge its displacement from its rear position, seen in FIG. 4 (and also seen in FIGS. 5A-5B, to be described below) into a front position (as seen in FIGS. 6A-6B to be described below).

Each of the brake elements 122 includes an arm 136 integrally formed with and extending upwardly from brake pad 126. In the position seen in FIG. 4, arm 136 bears against shoulders 138 of actuation element 124. Actuation element 124 is hinged to the frame about axle 140 and has an associated second urging element in the form of spring 142 that is fitted between forward extending appendage 144 and a portion (not shown) of the frame 118. Spring 142 biases the actuation element 124 about its axle 140 into its first state, seen in FIG. 4. In said first state shoulder 138 of actuation element 124 bears against arms 136, thus forcing brake elements into their rear position against the bias of their associated spring 134.

As seen in FIGS. 5A-5B, in the rear position of the brake element, rim-bearing face 128 is distanced from the wheel's rim 112. Once the user actuates the actuation mechanism, e.g. by pulling the brake lever in the illustrated embodiment, the actuation element is caused to pivot against the biasing force of the second urging member 142 (which will be clockwise rotation in the view seen in FIG. 4), whereby brake elements 122 are free to move in the forward direction by the bias of first urging members 134. The pivoted engagement with the frame with the generally parallel orientation of the pivot units has two effects. First, it ensures that the general orientation of the rim-bearing face, which is parallel to the rim, is maintained during movement of the brake elements. Second, during its forward movement, the rim-bearing face gradually proximates to the rim to eventually engage it as seen in FIGS. 6A-6B. Once the rim-bearing face comes into contact with the wheel's rim, the friction and the forward rotation of the wheel, represented by arrow 150 in FIGS. 5A and 6A, causes the brake element to continue to move forward by an additional increment, thereby inherently increasing the braking force in a manner unrelated to any actuation force applied on the brake lever by the user. Release of the lever then permits actuation element 124 to pivotally move under the bias of urging element 142 into its first state, seen in FIG. 4, thereby returning the braking element into the rear, non-braking position.

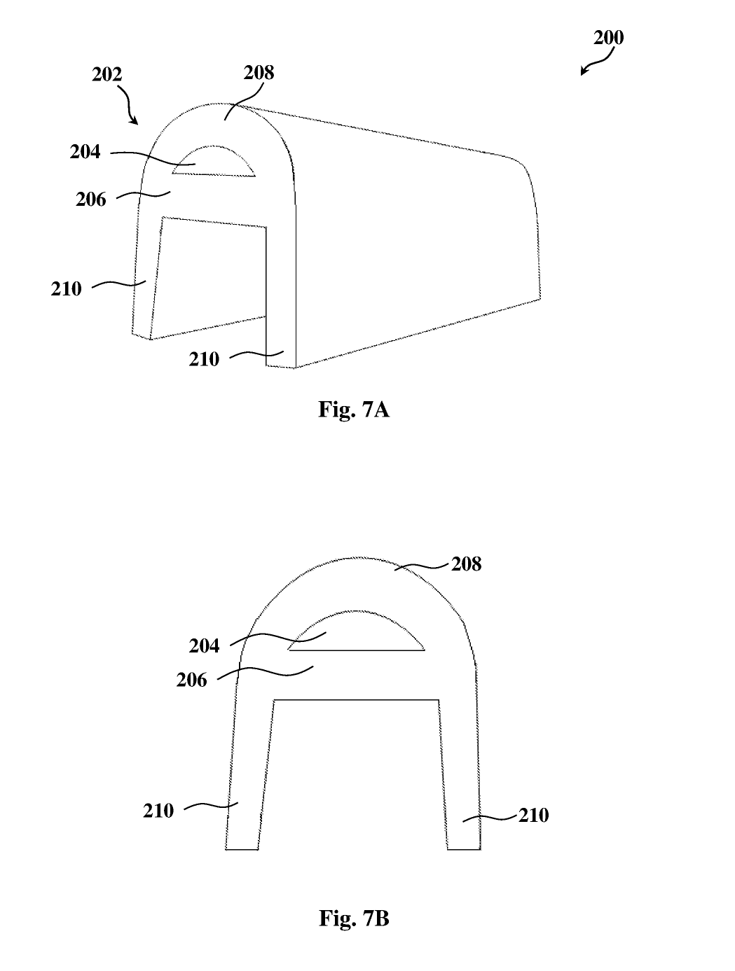

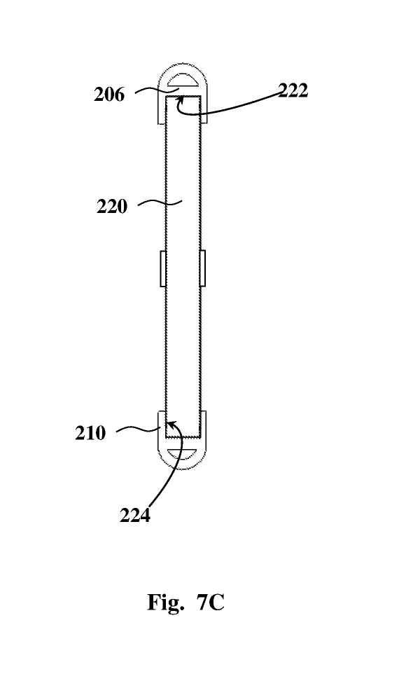

Reference is now made to FIGS. 7A-7C. The tire 200 shown in FIGS. 7A and 7B has a circumferential tire body 202 with a circumferential sealed compartment 204 that is defined between a tire base 206 and a circumferential ground-bearing portion 208 (which is rounded in this embodiment). Integrally formed with the tire body 202 are two flanking portions 210 integral with the tire body and generally parallel one to the other. The tire may be made of a variety of suitable materials, typically elastomeric. A specific example is vulcanized rubber.

The circumferential compartment 204 may be filled with a gas, which may air or any other (typically inert gas), which may be at atmospheric pressure or may be pressurized to a higher pressure. The compartment is sealed, which ensures that the gas will not leak out. Compartment 204 may also be, in addition or in the alternative, filled with an elastomeric material softer than the tire material. An example of such a material is a solid foam or spongy material.

FIG. 7C shows the tire 200 fitted over a wheel 220. As can be seen, the tire base 206 is associated with the wheel's circumferential surface 222 and the two flanking portion 210 are fitted over the wheel's two opposite rim portions 224. The association between the tire base 206 and the wheel's circumferential surface 222 or between the tire's two flanking portions 210 and the two rim portions 224 may be by adhering (e.g. by gluing) or by pressure fitting. The wheel 220 may have any suitable design or may be made of any material, for example, of cardboard, such as that disclosed in WO 2015/104701.

Once fitted onto a bicycle equipped with the braking system as described herein, in operation, the rim-bearing face of the brake pad (that bears no elastomeric material) is brought into contact with the tire's flanking portion. The friction between the brake pad and the flanking portion of the tire causes braking of the wheel's movement.

1. A rim brake system for a wheel having a wheel rim, comprising:
at least one brake element;
a frame holding at the least one brake element with a rim-bearing face that faces the wheel rim;
each of the at least one brake element being capable of reciprocating in a forward-rearward direction between front and rear positions and being biased by at least one first urging element into the front position, the elements being configured such that in their rear position the rim-bearing faces are distanced from the rim, while bearing on the rim in the front position;
an actuation element associated with a second urging element that can be displaced between first and second states and biased into the first state in which it forces the braking elements to be in their rear position against the bias of the first urging element; and
a user-operable actuation mechanism configured to switch the actuation element into its second state, whereby the brake element is free to move into its front position.

2. The rim brake system of claim 1, wherein each brake element is a member of a pair of brake elements that are opposite and face an opposite rim of the wheel than that of the other element of the pair.

3. The rim brake system of claim 1, wherein each brake element comprises:
a brake pad with the rim-bearing face that is generally parallel to the rim's side face and being hinged to a pivot arrangement configured to permit the forward-rearward reciprocation while maintaining the general parallel orientation of the rim-bearing face.

4. The rim brake system of claim 3, wherein the brake pad is generally planar.

5. The rim brake system of claim 3, wherein the pivot arrangement comprises a front pivot unit hinged to a front portion of the brake pad and a rear pivot unit hinged to a rear portion of the brake pad, the two pivots units having a general parallel orientation to one another.

6. The rim brake system of claim 5, wherein each of the pivot units is associated with a respective first urging member.

7. The rim brake system of claim 1, wherein each of the brake elements comprises an arm member engaging the actuation element.

8. The rim brake system of claim 1, wherein the actuation element being hinged to the frame and being displaceable in a hinged manner between the first and second states.

9. A rim brake system for a wheel having a wheel rim, comprising:
at least one brake element;
a frame holding at least one brake element with a rim-bearing face that faces the wheel rim, each of the at least one brake element being capable of displacement between a rim engaging state in which its rim-bearing face bears against the rim and a rim disengaging state in which its rim-bearing face is distanced from the rim;
wherein the rim-bearing face is devoid of an elastomeric material, and in that the brake element is configured so as cause the rim-bearing face to bear against a portion of the rim that includes or is fitted with an elastomeric material.

10. The rim brake system of claim 9, wherein the brake element is configured to cause the rim-bearing face to bear against the rim of a ground-bearing elastomeric element of the wheel.

11. The rim brake system of claim 10, wherein the wheel's rim is fitted with an elastomeric sheet and the brake element is configured to cause the rim-bearing face to bear against the sheet.

12. The rim brake system of claim 9, wherein the wheel is fitted with a tire comprising:
a circumferential tire body with a circumferential sealed compartment that is defined between a tire base associated with a circumferential surface of the wheel and a circumferential ground-bearing portion of the tire, and
two flanking portions integral with tire body, generally parallel one to the other and configured for fitting over a rim portion of the wheel, such that the rim bearing face of the brake element is configured to bear against the flaking portions.

13. A tire configured to be fitted onto a wheel of a wheeled device that include the rim brake system of claim 9, the tire comprising:
a circumferential tire body with a circumferential sealed compartment that is defined between a tire base and a circumferential ground-bearing portion, and
two flanking portions integral with tire body generally parallel one to the other.

14. The tire of claim 13 made of elastomeric material.

15. The tire of claim 14, wherein the elastomeric material is vulcanized rubber.

16. The tire of claim 13, wherein the circumferential compartment is filled with a gas, optionally pressurized or an elastomeric material softer than the tire material.

17. A wheel, comprising:
a wheel body,
a rim portion, and
a circumferential surface, the wheel is fitted with the tire of claim 13, such that the tire base is associated with the wheel's circumferential surface and the flanking portions of the tire being fitted over the rim portion of the wheel.

18. The wheel of claim 17, wherein the association between the tire base and the circumferential surface or between the flanking portions and the rim portions is by adhering or by pressure fitting.

19. The wheel of claim 17, wherein the wheel's body is made substantially of cardboard.

20. (canceled)

21. (canceled)

22. (canceled)
